(19) United States
(12) Patent Application Publication
(10) Pub. No.: US 2013/0111096 A1
(43) Pub. Date: May 2, 2013

(54) DOCKING DEVICE WITH A BUILT-IN NETWORK SHARE MODULE

(71) Applicant: Nai-Chien CHANG, New Taipei City (TW)

(72) Inventor: Nai-Chien CHANG, New Taipei City (TW)

(21) Appl. No.: 13/548,031

(22) Filed: Jul. 12, 2012

(30) Foreign Application Priority Data
Oct. 26, 2011 (TW) 100220109

(51) Int. Cl. G06F 13/00

(52) U.S. Cl. 710/303

(57) ABSTRACT

A docking device with a built-in network share module is coupled to an external electronic apparatus via a connector, thereby providing additional hardware functions to the electronic apparatus. The docking device is provided with a built-in network share module including a network input port, a wireless network chip, and an antenna unit. The docking device is coupled to an external modem via the network input port, so that the docking device can access the Internet via the modem. Further, the network share module is coupled to a processing unit inside the docking device, so that the electronic apparatus can access the Internet via the docking device and the modem. Further, the wireless network chip is configured to convert network signals and transmit the converted network signals to the outside via the antenna unit, thereby sharing the wireless network with the outside.

### BACKGROUND OF THE INVENTION

1. Field of the Invention

The present invention relates to a docking device for an electronic apparatus, and in particular to a docking device which is capable of allowing an electronic apparatus to access Internet and sharing a wireless network with the outside.

2. Description of Prior Art

Nowadays, electronic apparatuses are very popular. For example, computers, personal digital assistants (PDA), smart phones, and music players have been widely used in our daily life. Further, with the advancement of the semiconductor industry, the compact design of electronic apparatuses is the mainstream in the field of semiconductors.

In order to make a user to conveniently carry around an electronic apparatus such as a smart phone, the electronic apparatus is required to be made compact and lightweight. As a result, the manufacturer in this field has to arrange as many electronic elements as possible in a limited area and volume of the electronic apparatus and discard unnecessary hardware constructions. For example, in order to reduce the volume of the current smart phone, an actual keypad is eliminated, and thus a touch screen and a virtual keypad are provided to replace the traditional actual keypad.

Thus, a docking device is proposed in the market. FIG. 1 is a schematic view showing the connection of a conventional docking device. As shown in this figure, a male connector 21 of a docking device 2 is electrically connected to a female connector 11 of an electronic apparatus 1. A docking unit 22 provided in the docking device 2 can be used to provide additional hardware functions to the electronic apparatus 1.

As shown in FIG. 1, the electronic apparatus 1 is not equipped with an actual keypad. The user can use the touch screen of the electronic apparatus 1 to input data. However, when the user needs to use an actual keyboard, the user may have to use the docking device 2 as a keyboard to input data.

However, when the docking device 2 is not electrically connected to the electronic apparatus 1, that is not in use, the docking device 2 is inactive. As a result, it is a pity to leave the docking device 2 unused. Further, the docking device 2 occupies a certain space for storage.

It should be noted that most users need to use a wireless network router (not shown), whereby the electronic apparatus 1 can access the Internet via the wireless network router without the insertion of an Ethernet cable. However, the wireless network router can only transmit wireless network signals, but does not have other hardware functions. Further, the wireless network router also occupies a certain of space for storage.

If there are many docking devices 2 and the wireless network routers, it becomes a difficult thing for the user to store them. Therefore, it is an important issue for those skilled in this field to integrate maximum functions in a casing of an electronic device with a minimum space.

### SUMMARY OF THE INVENTION

The present invention is to provide a docking device with a built-in network share module, which is capable of allowing an electronic apparatus electrically connected thereto to access Internet and sharing a wireless network with the outside. In this way, the docking device also acts as a wireless network router.

The present invention provides a docking device with a built-in network share module, which is coupled to an external electronic apparatus via a connector, thereby providing additional hardware functions to the electronic apparatus. The docking device of the present invention is provided with a built-in network share module including a network input port, a wireless network chip, and an antenna unit. The docking device is coupled to an external modem via the network input port, so that the docking device can access the Internet via the modem. Further, the network share module is coupled to a processing unit inside the docking device, so that the electronic apparatus can access the Internet via the docking device and the modem. Further, the wireless network chip is configured to convert network signals and transmit the converted network signals to the outside via the antenna unit, thereby sharing the wireless network with the outside.

In comparison with prior art, the present invention has the following advantageous features. When the docking device is electrically connected to an electronic apparatus, the docking device provides additional hardware functions to the electronic apparatus. Further, the electronic apparatus can thereby access the Internet via the docking device and an external modem Further, the wireless network chip inside the docking device is configured to convert network signals, thereby sharing the wireless network with the outside. In this way, the docking device acts as a wireless network router, which occupies less space than prior art. Further, when the docking device is not electrically connected to the electronic apparatus and thus does not provide the additional hardware functions, the docking device can still operate to exhibit inherent functions.

### BRIEF DESCRIPTION OF DRAWING

FIG. 1 is a schematic view showing the connection of a conventional docking device;

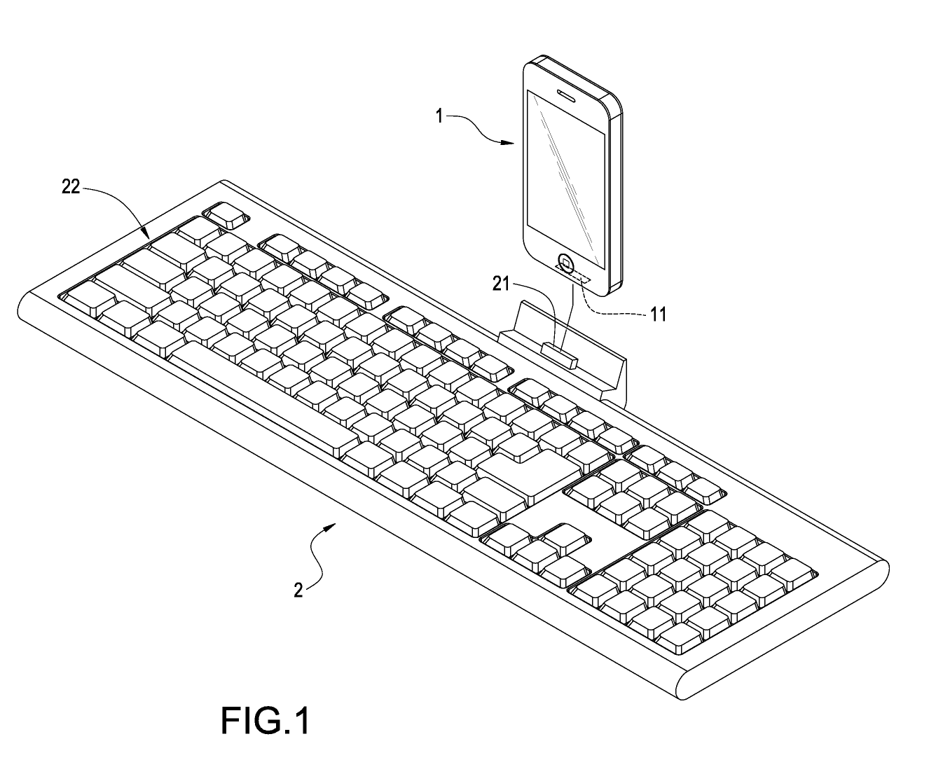

FIG. 2 is a schematic view showing the connection of the docking device according to a preferred embodiment of the present invention;

FIG. 3 is a circuit block view showing the docking device according to the preferred embodiment of the present invention; and

FIG. 4 is a schematic view showing the connection of the docking device according to another preferred embodiment of the present invention.

### DETAILED DESCRIPTION OF THE INVENTION

In order to better understand the features and technical contents of the present invention, a detailed description relating thereto will be made with reference to the accompanying drawings. It is noteworthy to point out that the drawings is provided for the illustration purpose only, but not intended for limiting the scope of the present invention.

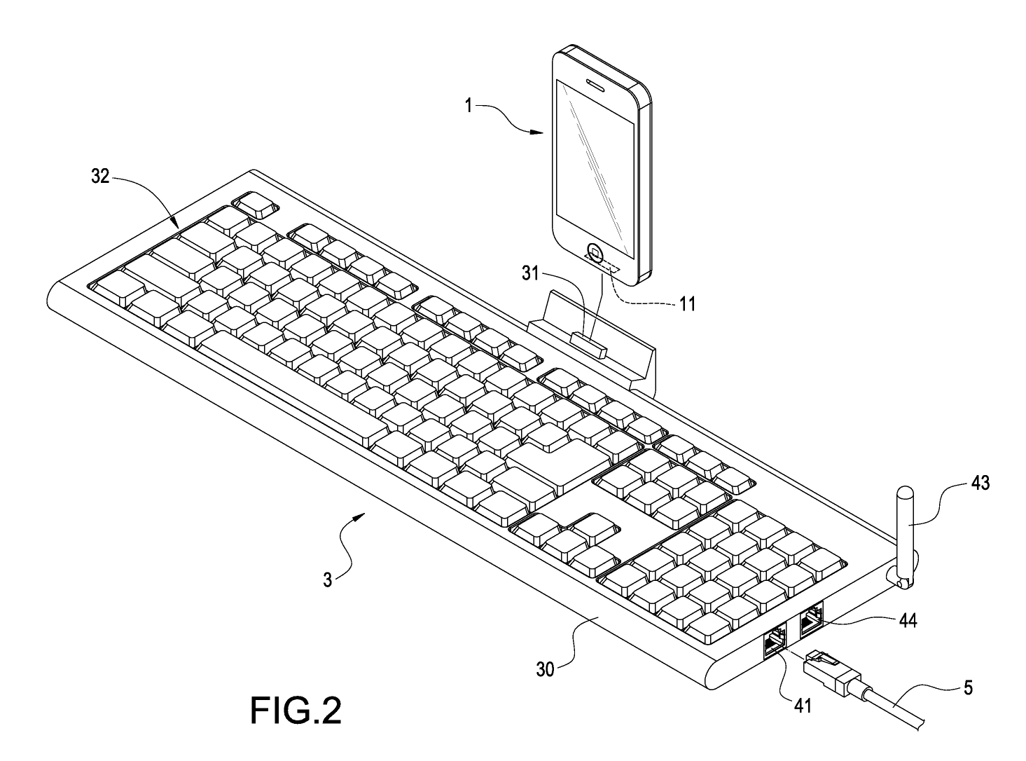

Please refer to FIG. 2, which is a schematic view showing the connection of the docking device according to a preferred embodiment of the present invention. The present invention provides a docking device 3 with a built-in network share module. The docking device 3 has a male connector 31 electrically connected to a female connector 11 of an external electronic apparatus 1. In this way, the hardware function provided by a docking unit 32 of the docking device 3 can be offered to the electronic apparatus 1. For example, in FIG. 2, the docking unit 32 is a keyboard, so that the docking unit 32 of the docking device 3 provides a keyboard function to the electronic apparatus 1, but it is not limited thereto.

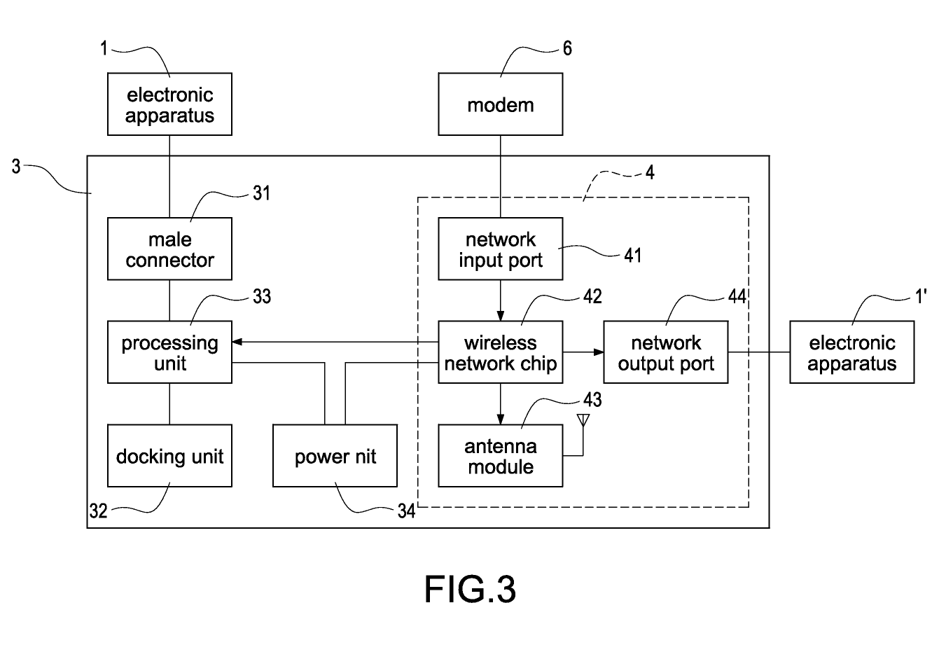

Please refer to FIG. 3, which is a circuit block view showing the docking device according to the preferred embodiment of the present invention. The docking device 3 has the male connector 31, the docking unit 32, a processing unit 33, a power unit 34, and a network share module 4. Further, the docking device 3 also has a casing 30 in which the male connector 31, the docking unit 32, the processing unit 33, the power unit 34 and the network share module 4 are disposed.

The processing unit 33 is electrically connected to the male connector 31 and the docking unit 32. The processing unit 33 is configured to process the signals transmitted from the electronic apparatus 1 and transmit the processed signals to the outside via the docking unit 32. For example, if the docking unit 32 is a speaker, the electronic apparatus 1 first decodes an audio file and then transmits the decoded signals to the docking device 3, thereby playing the decoded signals to the outside via the docking unit 32 of the docking device 3.

Further, the processing unit 33 is also configured to process signals transmitted from the docking unit 32 after an external operation, and then to transmit the processed signals to the electronic apparatus 1 via the male connector 31. For example, the docking unit 32 is a keyboard. The docking unit 32 is controlled by an external operation to transmit corresponding signals to the processing unit 33. After the processing unit 33 processes the received signals, the processed signals are transmitted to the electronic apparatus 1 via the male connector 31, thereby controlling the operation of the electronic apparatus 1.

The power unit 34 is electrically connected to the processing unit, thereby providing the electricity necessary for the docking device 3. In the present embodiment, the power unit 34 may be a power line or a battery, but it is not limited thereto.

The network share module 4 is electrically connected to the power unit 34, thereby obtaining the necessary electricity for its operation. The network share module 4 and the docking device 3 use a common power source. Further, the network share module 4 is electrically connected to the processing unit 33 and configured to transmit network signals to the processing unit 33. In this way, via the male connector 31, the function of accessing the Internet can be provided to the electronic apparatus 1 electrically connected to the docking device 3.

In the present embodiment, the network share module 4 further includes a network input port 41, a wireless network chip 42, an antenna module 43, and a network output port 44. The wireless network chip 42 is electrically connected to the network input port 41, the antenna module 43 and the network output port 44. Further, the network share module 4 is electrically connected to the processing unit 33 and the power unit 34 via the wireless network chip 42.

The network share module 4 is coupled to an external modem 6 via the network input port 41. More specifically, the network input port 41 allows an Ethernet cable 5 to be inserted therein. Thus, the network input port 41 is coupled to the modem 6 via the Ethernet cable 5 to thereby access the Internet via the modem 6. The wireless network chip 42 is configured to receive the network signals transmitted from the network input port 41. After the wireless network chip 42 processes the received signals, it transmits the processed signals to the processing unit 33. In this way, the processing unit 33 can provide the function of accessing the Internet to the electronic apparatus 1 via the male connector 31.

After the wireless network chip 42 receives the network signals transmitted from the network input port 41, the antenna module 43 is configured to transmit the received signals to the outside. In this way, the network share module 4 can share the wireless network with the outside. Thus, the modem 6 not only provides the function of accessing the Internet to the electronic apparatus 1 electrically connected to the docking device 3, but also shares the wireless network with the outside via the docking device 3 to thereby make the neighboring electronic apparatus to access the wireless network.

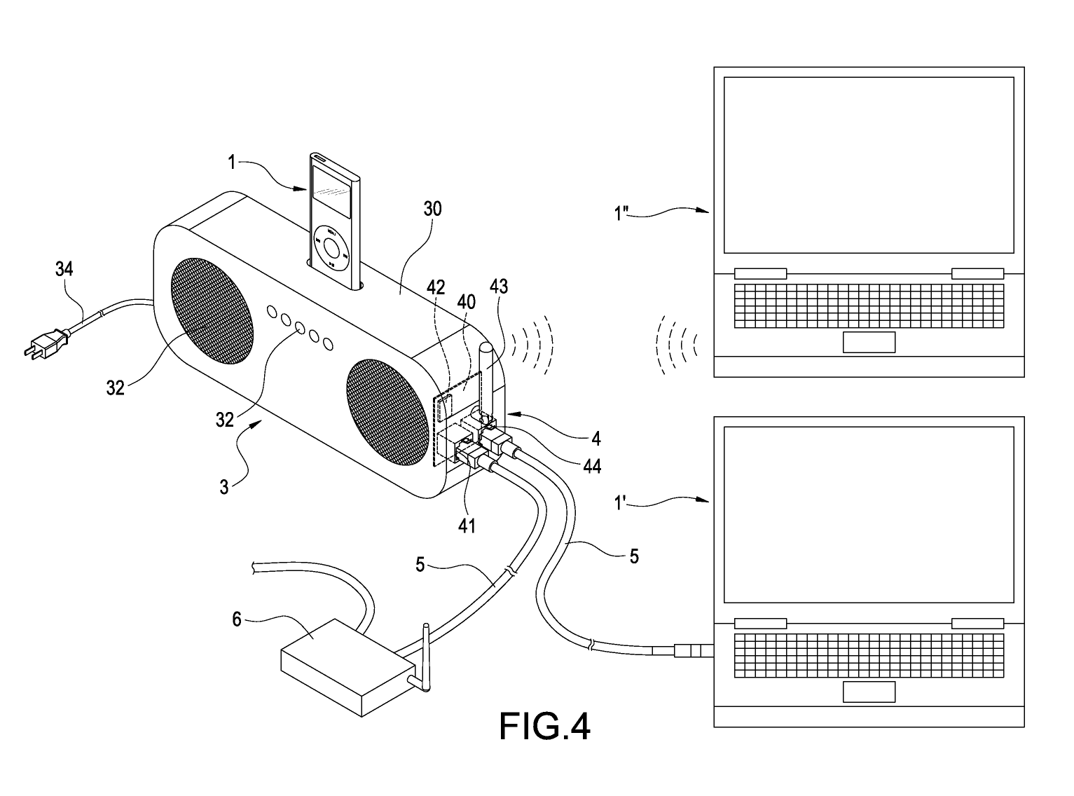

It should be noted that, the network share module 4 can be coupled to another electronic apparatus 1′ (such as another electronic apparatus 1′ shown in FIG. 4) via the network output port 44. More specifically, one end of the Ethernet cable 5 is inserted into the network output port 44, and the other end of the Ethernet cable 5 is connected to the another electronic apparatus 1′. By this arrangement, the docking device 3 establishes a wire connection between the another electronic apparatus 1′ and the modem 6, so that the another electronic apparatus 1′ can access the Internet via the modem 6.

Finally, please refer to FIG. 4, which is a schematic view showing the connection of the docking device according to another preferred embodiment of the present invention. As shown in this figure, the network share module 4 further includes a circuit board 40 on which the network input port 41, the wireless network chip 42, the antenna module 43, and the network output port 44 are electrically connected. The network share module 4 is directly disposed in the casing 30 of the docking device 3 via the circuit board 40 and thus electrically connected to the processing unit 33 and the power unit 34. By this arrangement, the time for manufacturing and assembling the docking device 3 can be reduced. However, the docking device 3 of the present invention is not limited to this arrangement only.

As shown in this figure, the male connector 31, the docking unit 32, the processing unit 33, the power unit 34 and the network share module 4 are disposed in the casing 30. On the other hand, the male connector 31, the network inlet port 41, the network outlet port 44, and the antenna module 43 protrude out of the casing 30, so that they can be used more easily.

In the embodiment of FIG. 4, the docking device 3 is an external stereo apparatus electrically connected to the electronic apparatus 1 via the male connector 31. The docking device 32 has a speaker and speaker control keys. The speaker control keys are controllably operated by a user to send control signals to the electronic apparatus 1 such as playing music or making a pause. Further, the docking device 3 receives the audio signals decoded and transmitted by the electronic apparatus 1 and plays the decoded audio signals via the speaker.

The network share module 4 is coupled to the modem 6 via the network input port 41, thereby accessing the Internet via the modem 6. Further, the network share module 4 shares the network with the electronic apparatus 1 via the processing unit 33 and the male connector 31. The docking device 3 also transmits wireless network signals to the outside via the antenna module 43 of the network share module 4. Further, another electronic apparatus 1″ can be wirelessly connected with the network share module 4 of the docking device 3, thereby accessing the Internet via the modem 6.

Further, the network share module 4 is connected to the another electronic apparatus 1′ via a Ethernet cable and the network output port 44. By this arrangement, the another electronic apparatus 1′ can access the Internet via the Ethernet cable and the modem 6.

Therefore, the docking device 3 can be electrically connected to the electronic apparatus 1, so that the docking unit 32 of the docking device 3 can provide additional hardware functions to the electronic apparatus 1. When the docking device 3 is coupled to the modem 6 via the network input port 41, the docking device 3 can provide a function of accessing the Internet to the electronic apparatus 1 electrically connected to the docking device 1. Next, the docking device 3 can share the wireless network with the outside via the antenna module 43, so that the docking device 3 can act as a wireless network router to thereby establish a wireless connection with another electronic apparatus 1″. Finally, the network output port 44 of the docking device 3 is connected to another electronic apparatus 1′ via a Ethernet cable, so that the another electronic apparatus 1′ can be coupled to the modem 6 via the docking device 3 and thus access the Internet via the modem 6.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A docking device with a built-in network share module, electrically connected to an electronic apparatus to provide a hardware function to the electronic apparatus, the docking device comprising:
a male connector, electrically connected to a female connector of the electronic apparatus;
a docking unit, configured to provide the hardware function;
a processing unit, electrically connected to the male connector and the docking unit for processing signals transmitted from the electronic apparatus and for playing the processed signals via the docking unit, the processing unit being configured to also process signals transmitted by the docking unit after an external operation and to transmit the processed signals to the electronic apparatus via the male connector;
a power unit, electrically connected to the processing unit for providing electricity necessary for the docking device; and
a network share module, electrically connected to the processing unit and the power unit to receive the necessary electricity via the power unit, the network share module being configured to transmit network signals to the processing unit to thereby provide a function of accessing Internet to the electronic apparatus via the male connector.

2. The docking device with a built-in network share module according to claim 1, further comprising;
a network input port, whereby the docking device is coupled to an external modem to access Internet via the external modem;
a wireless network chip, electrically connected to network input port for processing network signals from the modem and transmitting the processed signals to the processing unit; and
an antenna module, electrically connected to the wireless network chip for receiving the network signals processed by the wireless network chip and sharing the wireless network to the outside.

3. The docking device with a built-in network share module according to claim 2, further comprising a network output port electrically connected to the wireless network chip, the network output port being coupled to another electronic apparatus via a Ethernet cable, so that the another electronic apparatus can be coupled to the modem via the docking device.

4. The docking device with a built-in network share module according to claim 3, further comprising a circuit board on which the network input port, the wireless network chip, the antenna module and the network output port are electrically connected.

5. The docking device with a built-in network share module according to claim 4, further comprising a casing in which the male connector, the processing unit, the docking unit, the power unit and the network share module are disposed, and the male connector, the network input port, the network output port and the antenna module protrude out of the casing.

6. The docking device with a built-in network share module according to claim 2, wherein the power unit is a power line.

7. The docking device with a built-in network share module according to claim 2, wherein the power unit is a battery.

8. The docking device with a built-in network share module according to claim 2, wherein the docking unit is a keyboard.

9. The docking device with a built-in network share module according to claim 2, wherein the docking unit is a speaker or speaker control keys.
